(19) United States
(12) Patent Application Publication
(10) Pub. No.: US 2012/0074117 A1
(43) Pub. Date: Mar. 29, 2012

(54) IN-SITU HEATING AND CO-ANNEALING FOR LASER ANNEALED JUNCTION FORMATION

(75) Inventors: Deepak Ramappa, Cambridge, MA (US); Paul Sullivan, Wenham, MA (US)

(73) Assignee: VARIAN SEMICONDUCTOR EQUIPMENT ASSOCIATES, INC., Gloucester, MA (US)

(21) Appl. No.: 13/238,687

(22) Filed: Sep. 21, 2011

Related U.S. Application Data
(60) Provisional application No. 61/385,779, filed on Sep. 23, 2010.

(51) Int. Cl. B23K 26/00

(52) U.S. Cl. 219/200

(57) ABSTRACT

Improved methods of annealing a workpiece are disclosed. Lasers are used to both increase the temperature of the workpiece, and to laser melt anneal the workpiece. By utilizing lasers for both operations, the manufacturing complexity is reduced. Furthermore, laser melt anneal may provide better junctions and more well defined junction depths. By heating the workpiece either immediately before or after the laser melt anneal, the quality of the junction may be improved. Shallow annealing may be accomplished and annealing may occur in the presence of a species to form a passivation layer. If the workpiece is a solar cell, in-situ heating may improve open circuit voltage (V_{oc}) or dark currents. Insitu heating of the substrate lowers the melting threshold of the substrate and also increases light absorption in the substrate. This reduces the power of the melt laser and hence reduces the residual damage.

This application claims priority of U.S. Provisional Patent Application Ser. No. 61/385,779, filed Sep. 23, 2010, the disclosure of which is incorporated herein by reference in its entirety.

### FIELD

This invention relates to laser annealing and, more particularly, to laser melt annealing of implanted workpieces.

### BACKGROUND

An ion implanter includes an ion source for converting a gas or a solid material into a well-defined ion beam. The ion beam typically is mass analyzed to eliminate undesired ion species, accelerated to a desired energy, and implanted into a target. The ion beam may be distributed over the target area by electrostatic or magnetic beam scanning, by target movement, or by a combination of beam scanning and target movement. The ion beam may be a spot beam or a ribbon beam having a long dimension and a short dimension.

Laser annealing or laser melt annealing may be used to infuse dopants from the ion beam into a workpiece or activate a dopant from the ion beam to form junctions in a workpiece. This workpiece may be, for example, a semiconductor wafer or a solar cell. There are many ways a dopant may be incorporated into the workpiece.

First, solid source drive-in may be used. In this case, the dopant is a solid source at the surface of the workpiece and is driven into the workpiece. Laser energy is absorbed in the surface solid source and is thermally driven into the workpiece below. In some instances, the laser energy also is absorbed in the workpiece and aids diffusion of the dopant into the workpiece and incorporation the dopant.

Second, solid source melt annealing may be used. This is similar to the previous technique in that the dopant is a solid source at the surface of the workpiece. However, in this scenario, the laser energy is sufficient so that the dopant is thermally melted into the workpiece below. Laser energy is absorbed in the solid source and also the workpiece. This embodiment may involve intermixing the melted areas to incorporate the dopant.

Third, implanted source activated annealing may be used. In this scenario, the dopant is implanted into the workpiece, such as using an ion beam or plasma processing apparatus, and then the laser energy is absorbed in the workpiece to thermally activate the dopant or incorporate the dopant into the workpiece.

Fourth, implanted source melt annealing may be used. This is similar to the previous technique in that the dopant is implanted into the workpiece using an ion beam or a plasma processing apparatus. Laser energy of a sufficient energy is absorbed into the workpiece to thermally melt the workpiece so that the dopant and workpiece are mixed together and recrystallize together.

Laser annealing of junctions may lead to residual damage in the junction. Silicon interstitials accumulate at the junction boundary and may lead to carrier recombination. Also, laser annealing may lead to dopant accumulation or clustering, which likewise may lead to carrier recombination. Additional annealing after the laser anneal, such as using a furnace or rapid thermal anneal (RTA), can improve the quality of these junctions that have residual damage. In-situ workpiece heating also may have the same effect and may affect dopant profiles. For example, FIG. 1 shows the effects of substrate temperature on dopant profile. Increased substrate temperature distributes the dopant deeper into the substrate and provides more uniform distribution. Specifically, line 700 shows the dopant concentration as implanted. Line 701 shows the dopant profile when the substrate is heated to 600° C.

In addition, the in-situ workpiece heating may affect the operating parameters of the workpiece. In one example, shown in FIG. 2, various parameters for a solar cell were measured as a function of substrate temperature. Substrate heating to 400° C. during laser anneal improves open circuit voltage (V_{oc}). Increased heating also helps reduce dark currents (J_{sc}). Note also that fill factor (FF), which is another term used to define the overall behavior and performance of a solar cell, also improves at increased substrate temperatures.

However, previous methods of heating have used heated platens, optical lamps, or RF heating. Combining such methods with a laser adds complexity in wafer handling, lowers throughput, or adds cost to the overall system. Accordingly, there is a need in the art for a method that uses only laser beams to anneal a workpiece.

### SUMMARY

Improved methods of annealing a workpiece are disclosed. Lasers are used to both increase the temperature of the workpiece, and to laser melt anneal the workpiece. By utilizing lasers for both operations, the manufacturing complexity is reduced. Furthermore, laser melt anneal may provide better junctions and more well defined junction depths. By heating the workpiece either immediately before or after the laser melt anneal, the quality of the junction may be improved. Shallow annealing may be accomplished and annealing may occur in the presence of a species to form a passivation layer. If the workpiece is a solar cell, in-situ heating may improve open circuit voltage (V_{oc}) or dark currents. Insitu heating of the substrate lowers the melting threshold of the substrate and also increases light absorption in the substrate. This reduces the power of the melt laser and hence reduces the residual damage.

### BRIEF DESCRIPTION OF THE DRAWINGS

For a better understanding of the present disclosure, reference is made to the accompanying drawings, which are incorporated herein by reference and in which:

FIG. 1 is a graph showing the effects of substrate temperature on dopant profile;

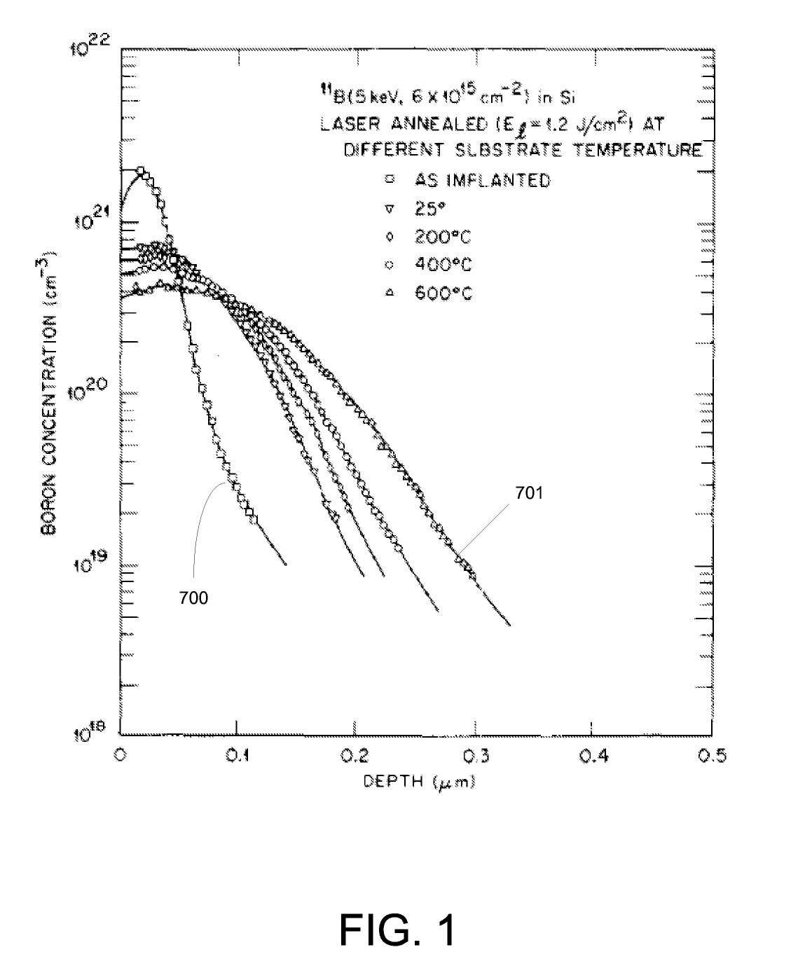

FIG. 2 is a graph showing various parameters for a solar cell as a function of substrate temperature;

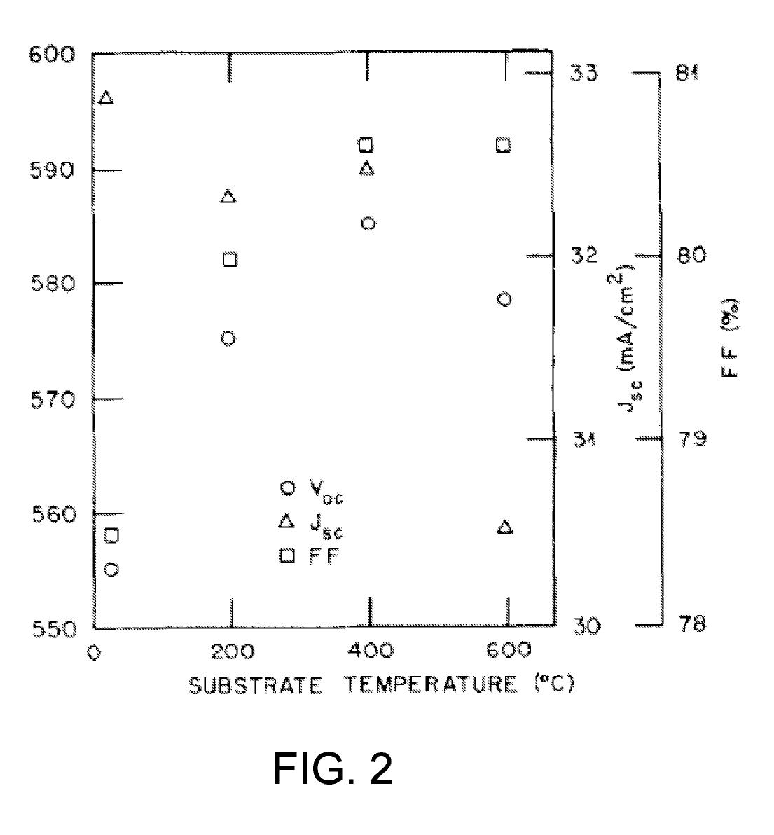

FIG. 3 is a block diagram illustrating one embodiment of laser annealing;

FIG. 4 is a block diagram illustrating a second embodiment of laser annealing;

FIG. 5 is a block diagram illustrating a third embodiment of laser annealing;

FIG. 6 is a block diagram illustrating a fourth embodiment of laser annealing;

FIG. 7 is a block diagram illustrating a fifth embodiment of laser annealing; and

FIG. 8 is a graph showing the relative width and intensity of the beams in the embodiment of FIG. 7.

### DETAILED DESCRIPTION

The method and apparatus are described herein may be applied to implanted ions, forming a junction with a solid dopant sources on the surface, or a combination of these two. Any dopant known to those skilled in the art may be annealed. Thus, the invention is not limited to the specific embodiments described below.

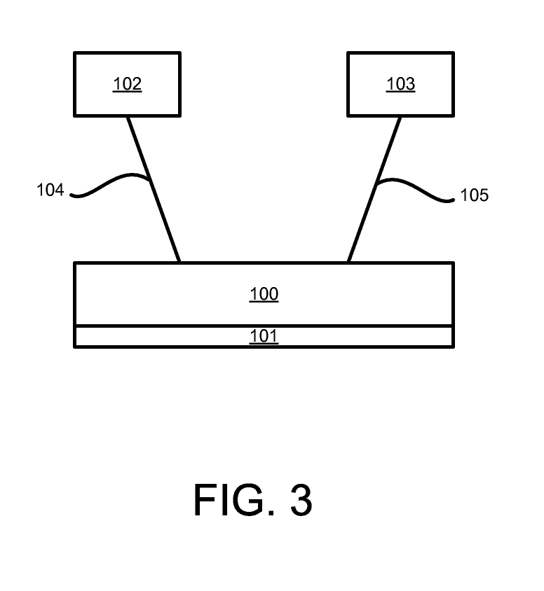

FIG. 3 is a block diagram illustrating one embodiment of laser annealing. The workpiece 100, which may be, for example, a semiconductor wafer or solar cell, is disposed on a support 101. The support 101 may use, for example, mechanical or electrostatic clamping. A first laser 102 and a second laser 103 are disposed overhead, though these may be positioned elsewhere. The first laser 102 generates a first laser beam 104. The second laser 103 generates a second laser beam 105. One of the first laser 102 and the second laser 103 is a long wavelength laser, while the other may not be. The particular types of laser and wavelengths are configured so that one allows laser melt and the other heats the workpiece 100. Different laser types and wavelengths known to those skilled in the art may be used. Laser beam 104 and laser beam 105 may be directed at the workpiece simultaneously, or at least partially simultaneously.

The embodiment of FIG. 3 can preheat the workpiece 100 using a long wavelength laser prior to junction laser annealing. This enables junction formation by laser melt while the long wavelength laser heats the workpiece 100 at approximately the same time. In one particular embodiment, the first laser 102 is a long wavelength laser, such as 1060 nm or greater, which serves to heat the workpiece 100. The second laser 103 is a shorter wavelength laser which performs the laser melt anneal. The embodiment of FIG. 3 can heat the workpiece 100 simultaneously using both the first laser beam 104 and the second laser beam 105. In one embodiment, these lasers 102, 103 cooperate to move in concert such that the first laser beam 104 heats the workpiece 100 just prior to its annealing by the second laser beam 105. In one instance, the first laser beam 104 and second laser beam 105 scan together across the workpiece 100, with one scanning ahead of the other. The first laser beam 104 may preheat or heat after junction formation. Alternatively, the lasers 102, 103 may be in fixed locations, and the workpiece 100 may be moved relative to the lasers 102, 103 such that laser beam 104 strikes the workpiece 100 prior to laser beam 105.

This relative movement of the lasers 102, 103 and the workpiece 100 may be used to scan the entire surface of the workpiece 100. In another embodiment, the relative motion is used to position the laser beams 104, 105 so as to anneal only those areas that were implanted. For example, in the case of a selective emitter, the lasers 102, 103 and the workpiece 100 may be moved so that the laser beams 104, 105 move in stripes. Other patterns, such as the back side of an interdigitated back contact (IBC) solar cell, can also be annealed in this way. By annealing only those areas that were implanted, power and time are both conserved.

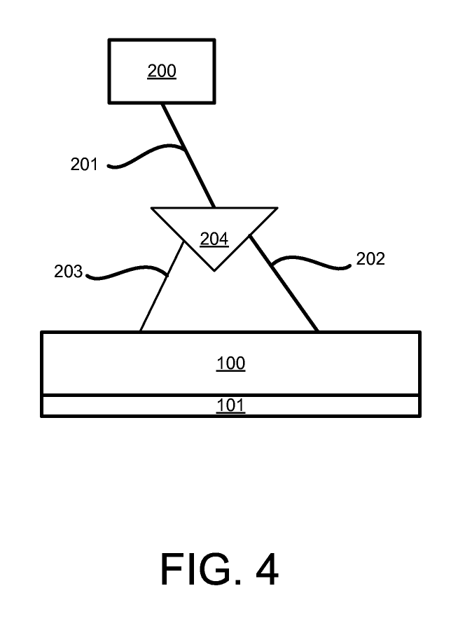

In one specific instance, shown in FIG. 4, a single laser 200 is used. The laser beam 201 is split into two sections 202, 203, such as using an optical device 204, such as a prism, lens, mirror or any combination of these. One of the laser beams 202, 203 has reduced power such that it heats the workpiece 100 without melting it. This enables simultaneous junction formation and heating. The laser selected may have the desired wavelength wherein absorption of the laser occurs throughout the workpiece 100 to enable heating.

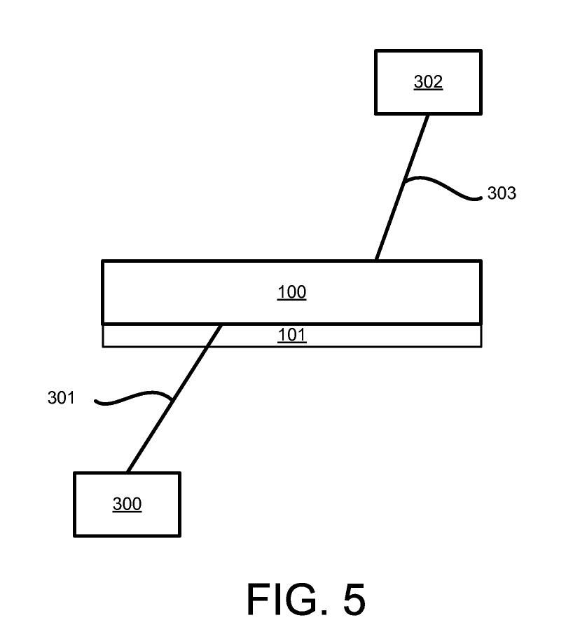

In an alternate embodiment, shown in FIG. 5, heating is performed on one side of the workpiece 100 using laser 300, while laser melting is performed on the other side of the workpiece 100 using laser 302. In this embodiment, the laser beam 301, used for heating, may be a long wavelength, such as greater than 1060 nm. Light from laser 300 must pass through a workpiece support 101 to enter the workpiece 100. This may be accomplished by using a platen or workpiece support 101 that is made of a material that is transparent to the laser 300 at a particular wavelength. There are quartz and undoped silicon materials that can achieve this. Laser beam 301 and laser beam 303 may be directed at the workpiece simultaneously, or at least partially simultaneously.

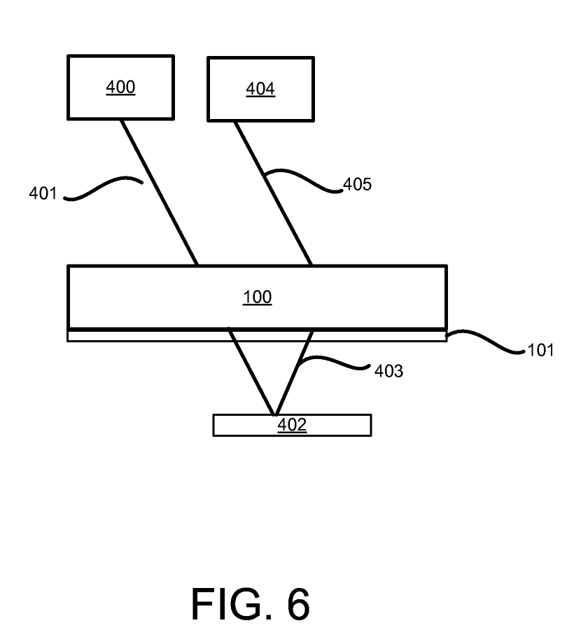

In another embodiment, mirrors are used to promote heating. FIG. 6 shows a first embodiment using a mirror. In this embodiment, two lasers 400, 404 are used, where some of the energy from laser beam 401 passes through the workpiece 100. This unabsorbed light then reflects off mirror 402 and re-enters the workpiece 100 as laser beam 403 via the opposite side of the workpiece 100. This reflected laser beam 403 serves to heat the workpiece 100. Laser beam 405 is used to melt the junction. In some embodiments, the first laser beam 400 may have a longer wavelength which is only partially absorbed by the workpiece 100, while the second laser beam 404 has a shorter wavelength that is more completely absorbed by the workpiece 100. As described above, the workpiece support 101 may be transparent to the wavelength of laser 400. Laser beam 401 and laser beam 405 may be directed at the workpiece simultaneously, or at least partially simultaneously.

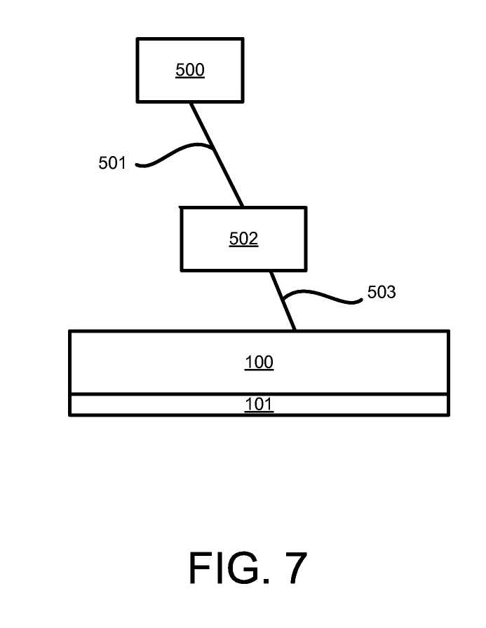

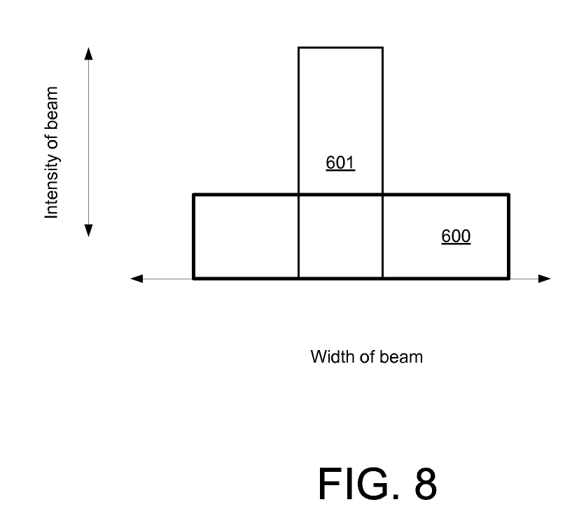

In another embodiment, shown in FIG. 7, the laser 500 emits a laser beam 501 having a wide range of wavelengths, where some wavelengths are short and capable of being completely absorbed by the workpiece 100 and other wavelengths are longer and are only partially absorbed. An optic system 502 may be used to separately manipulate these wavelengths. For example, the longer wavelengths may be spread across a wider area, while the shorter wavelengths are more narrowly focused. In addition, the amplification or attenuation of these wavelengths may vary, such that the shorter wavelengths, which are used for the laser melt, have greater intensity than the longer wavelengths. FIG. 8 shows a representative graph showing the width of each respective wavelength and its associated intensity. The longer wavelengths 600 have a wider beam width and a lower intensity than the shorter wavelengths 601. In this way, the beam of longer wavelengths 600 serves to heat the workpiece 100 before the beam of shorter wavelengths melts the workpiece as the laser is scanned across the workpiece.

In yet another alternate embodiment, any of the previous embodiments, shown in FIGS. 3-7, are combined with LED heat lamps.

Furthermore, the lasers described in any of these embodiments may be moved relative to the workpiece 100 so as to scan the entire workpiece. In other embodiments, the lasers are moved relative to the workpiece 100 to only anneal those portions of the workpiece that were implanted.

In some embodiments, these lasers are used in conjunction with the processing of a solar cell.

The methods disclosed herein can be performed in a chamber having a specific ambient condition to provide additional benefits. For example, in an oxygen rich ambient environment, a thin layer of oxide may be formed on the surface, which may serve to passivate the surface. In another example, a nitrogen rich environment can be used to grow a nitride layer on the surface of the workpiece.

The method and apparatus disclosed herein enable better quality junctions due to in-situ laser heating. Shallow annealing may be accomplished and annealing may occur in the presence of a species to form a passivation layer. If the workpiece is a solar cell, in-situ heating may improve open circuit voltage (V_{oc}) or dark currents.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A method of laser melt annealing a workpiece, comprising:
directing an incoming laser beam toward a workpiece;
dividing said incoming laser beam into a first laser beam and a second laser beam using an optical device disposed in a path of said incoming laser beam, wherein said first laser beam has a first wavelength at a first power level, to heat said workpiece and said second laser beam has a second wavelength at a second power level to laser melt anneal said workpiece.

2. The method of claim 1, wherein said optical device is selected from the group consisting of a lens, prism, mirror and any combination thereof.

3. The method of claim 1, wherein said optical device divides said incoming laser beam such that said first power level is less than said second power level.

4. The method of claim 1, wherein said optical device divides said incoming laser beam such that said first laser beam has a greater width than said second laser beam.

5. The method of claim 1, wherein said first laser beam and said second laser beam are moved relative to said workpiece.

6. A method of laser melt annealing a workpiece, comprising:
directing a first laser beam, having a first wavelength at a first power level, toward said workpiece to heat said workpiece; and
directing a second laser beam, at least partially simultaneously with said first laser beam, said second laser beam having a second wavelength at a second power level, toward said workpiece to laser melt anneal said workpiece, wherein said first laser beam and said second laser beam are directed at opposite sides of said workpiece.

7. The method of claim 6, wherein said first wavelength is longer than said second wavelength.

8. The method of claim 6, wherein said first power level is less than said second power level.

9. The method of claim 6, wherein said first laser beam and said second laser beam are moved relative to said workpiece.

10. A method of laser melt annealing a workpiece, comprising:
implanting a portion of said workpiece;
directing a first laser beam, having a first wavelength at a first power level, toward said workpiece to heat said portion of said workpiece;
directing a second laser beam, at least partially simultaneously with said first laser beam, said second laser beam having a second wavelength at a second power level, toward said portion of said workpiece to laser melt anneal said workpiece;
and wherein said first laser beam and said second laser beam are moved relative to said workpiece so as to anneal only said implanted portions of said workpiece.

11. The method of claim 10, wherein said first wavelength is longer than said second wavelength.

12. The method of claim 10, wherein said first power level is less than said second power level.

13. A method of laser melt annealing a workpiece, comprising:
directing a first laser beam, having a first wavelength at a first power level, toward said workpiece to heat said workpiece; and
directing a second laser beam, at least partially simultaneously with said first laser beam, said second laser beam having a second wavelength at a second power level, toward said workpiece to laser melt anneal said workpiece, wherein said first laser beam is directed toward a first side of said workpiece and is reflected back toward said workpiece using a mirror positioned on a second side opposite said first side.

14. The method of claim 13, wherein said first wavelength is longer than said second wavelength.

15. The method of claim 13, wherein said first power level is less than said second power level.

16. The method of claim 13, wherein said first laser beam and said second laser beam are moved relative to said workpiece.
